(19) United States
(12) Patent Application Publication
(10) Pub. No.: US 2006/0227800 A1
(43) Pub. Date: Oct. 12, 2006

(54) Rate determination for scheduling users on a time shared packet data channel

(75) Inventor: Patrick A. Hosein, San Diego, CA (US)

Correspondence Address: COATS & BENNETT, PLLC, P O BOX 5, RALEIGH, NC, 27602, US

(73) Assignee: Telefonaktiebolaget LM Ericsson (publ)

(21) Appl. No.: 11/101,222

(22) Filed: Apr. 7, 2005

(51) Int. Cl. H04J 3/16

(52) U.S. Cl. 370/437

(57) ABSTRACT

A scheduler at a base station uses a continuous function to determine achievable rates of mobile stations communicating with the base station over a shared packet data channel. The scheduler receives channel quality feedback from mobile stations using the shared channel and determines achievable rates for said mobile stations using the continuous function based on said channel quality feedback.

### BACKGROUND OF THE INVENTION

The present invention relates to mobile communication systems and, more particularly, to methods of scheduling multiple users on a time shared packet data channel.

The demand for wireless data services, such as mobile Internet, video streaming, and voice over IP, have led to the development of high speed packet data channels to provide high data rates needed for such services. High speed packet data channels are employed on the forward link in IS-2000 (also known as 1xEV-DV) and Wideband Code Division Multiple Access (WCDMA) systems. The high speed packet data channel is a time shared channel. Transmissions from a base station to the mobile stations are time-multiplexed and transmitted at full power. At any given time, the base station transmits to only one mobile station.

Deciding which terminal to serve at a given time is the function of a “scheduler.” A number of different scheduling strategies can be used, each with a different implication for system throughput and fairness. Typical scheduling strategies include round-robin scheduling, maximum throughput scheduling, and proportional fairness scheduling. In round-robin scheduling, the scheduler assigns the same number of time slots to all users, or assigns time slots on a first-come, first-serve basis, without taking into account channel conditions. Round-robin scheduling achieves a measure of fairness, but at the expense of lower throughput. Maximum throughput scheduling and proportional fairness scheduling, in contrast, attempt to increase system throughput as compared to round-robin scheduling by taking into account current channel conditions. A maximum throughput scheduler favors mobile stations with the best channel conditions and hence the highest supportable data rate to maximize system throughput. Proportional fairness scheduling tempers maximum throughput scheduling with a fairness criteria, so that mobile stations with bad channel conditions for an extended period can be served.

The scheduler makes scheduling decisions and selects the appropriate modulation and coding schemes based on channel feedback from the mobile stations. In 1xEV-DV and WCDMA systems, the mobile stations measure the quality of the forward packet data channel and transmit a channel quality indicator (CQI) to the base station. The base station maps the reported CQI value to one of a set of predefined modulation and coding schemes. The selected modulation and coding scheme determines the data rate for transmission. The scheduled rate determined from the selected modulation and coding scheme is then used by the scheduler to make scheduling decisions.

In some systems, the number of CQI levels is higher than the number of supportable data rates so that two different CQI levels will map to the same supportable data rate. In this case, the scheduler will not be able to take into account differences in channel conditions between the two mobile stations, since the supportable data rate is the same for both. Consequently, one user may be scheduled when it would have been more efficient to schedule another.

### SUMMARY OF THE INVENTION

A scheduler at a base station uses a continuous function to determine achievable rates of mobile stations communicating with the base station over a shared packet data channel. The scheduler receives channel quality feedback from mobile stations using the shared channel and determines achievable rates for said mobile stations using the continuous function based on said channel quality feedback. By using a continuous function to determine achievable rates, the base station can take into account small differences in channel conditions that could not be previously taken into account.

### BRIEF DESCRIPTION OF THE DRAWINGS

FIG. 1 illustrates an exemplary mobile communication network.

FIG. 2 illustrates an exemplary base station for a mobile communication network.

FIG. 3 illustrates an exemplary mobile station for a mobile communication network.

FIGS. 4A and 4B are graphs illustrating the achievable rate of a mobile station versus the carrier to interference ratio for 1 xEV-DV and WCDMA systems respectively.

### DETAILED DESCRIPTION OF THE INVENTION

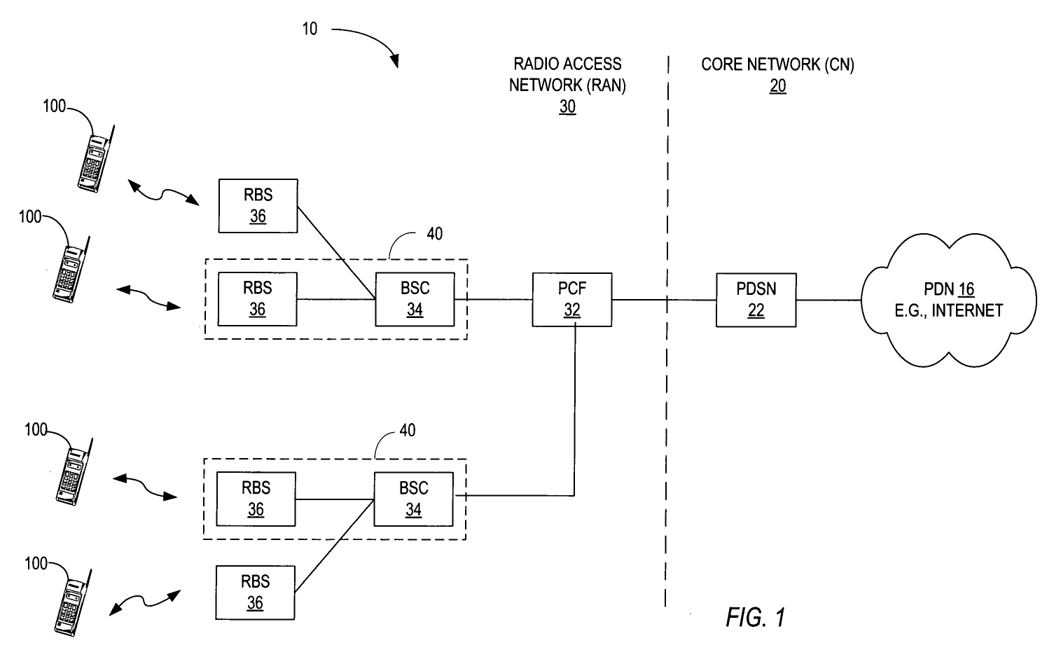

FIG. 1 illustrates logical entities of an exemplary wireless communication network 10 that provides packet data services to mobile stations 100. FIG. 1 illustrates a wireless communication network 10 configured according to the IS-2000 standard. Other standards, including Wideband CDMA (W-CDMA) systems could also be employed.

The wireless communication network 10 is a packet-switched network that employs a high-speed forward packet data channel (F-PDCH) to transmit data to the mobile stations 100. Wireless communication network 10 comprises a packet-switched core network 20 and a radio access network (RAN) 30. The core network 20 includes a Packet Data Serving Node (PDSN) 22 that connects to an external packet data network (PDN) 16, such as the Internet, and supports PPP connections to and from the mobile station 100. Core network 20 adds and removes IP streams to and from the RAN 30 and routes packets between the external packet data network 16 and the RAN 30.

RAN 30 connects to the core network 20 and gives mobile stations 100 access to the core network 20. RAN 30 includes a Packet Control Function (PCF) 32, one or more base station controllers (BSCs) 34 and one or more radio base stations (RBSs) 36. The primary function of the PCF 32 is to establish, maintain, and terminate connections to the PDSN 22. The BSCs 34 manage radio resources within their respective coverage areas. The RBSs 36 include the radio equipment for communicating over the air interface with mobile stations 100. A BSC 34 can manage more than one RBSs 36. In cdma2000 networks, a BSC 34 and an RBS 36 comprise a base station 40. The BSC 34 is the control part of the base station 40. The RBS 36 is the part of the base station 40 that includes the radio equipment and is normally associated with a cell site. In cdma2000 networks, a single BSC 34 may comprise the control part of multiple base stations 40. In other network architectures based on other standards, the network components comprising the base station 40 may be different but the overall functionality will be the same or similar.

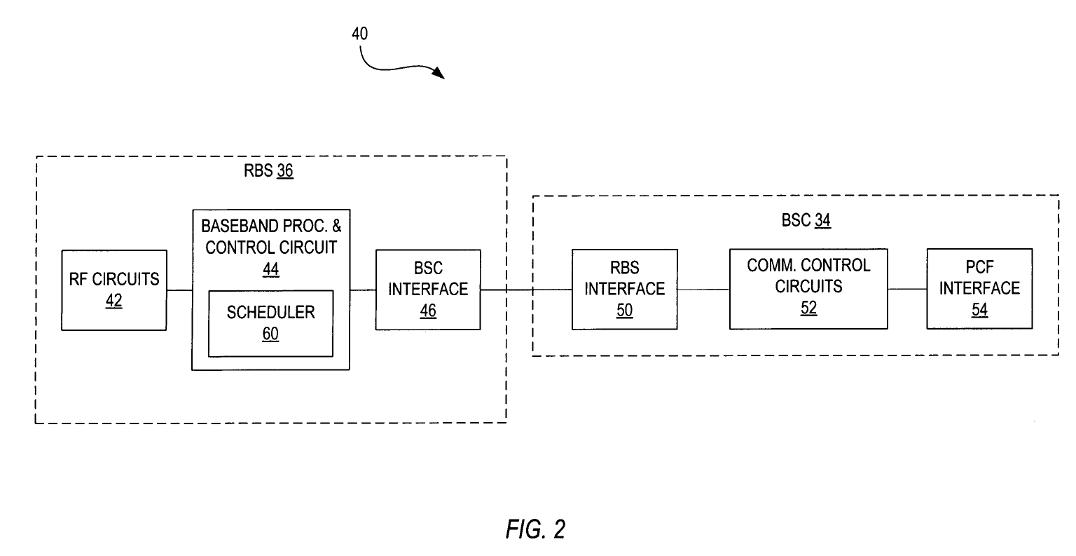

FIG. 2 illustrates exemplary details of a base station 40 in a cdma2000 network. The base station components in the exemplary embodiment are distributed between a RBS 36 and a BSC 34. The RBS 36 includes RF circuits 42, baseband processing and control circuits 44, and interface circuits 46 for communicating with the BSC 34. The baseband processing and control circuits 44 perform baseband processing of transmitted and received signals. In the embodiment shown in FIG. 2, the baseband processing and control circuit 44 includes a scheduler 60 to schedule packet data transmissions on the Forward Packet Data Channel (F-PDCH). The baseband processing and control circuit 44 may be implemented in software, hardware, or some combination of both. For example, the baseband processing and control circuit 44 may be implemented as stored program instructions executed by one or more microprocessors or other logic circuits included in RBS 36.

The BSC 34 includes interface circuits 50 for communicating with the RBS 36, communication control circuits 52, and interface circuits 54 for communicating with the PCF 32. The communication control circuits 52 manage the radio and communication resources used by the base station 40. The communication control circuits 52 are responsible for setting up, maintaining and tearing down communication channels between the RBS 36 and mobile station 100. The communication control circuits 52 may also allocate Walsh codes and perform power control functions. The communication control circuits 52 may be implemented in software, hardware, or some combination of both. For example, the communication control circuits 52 may be implemented as stored program instructions executed by one or more microprocessors or other logic circuits included in BSC 34.

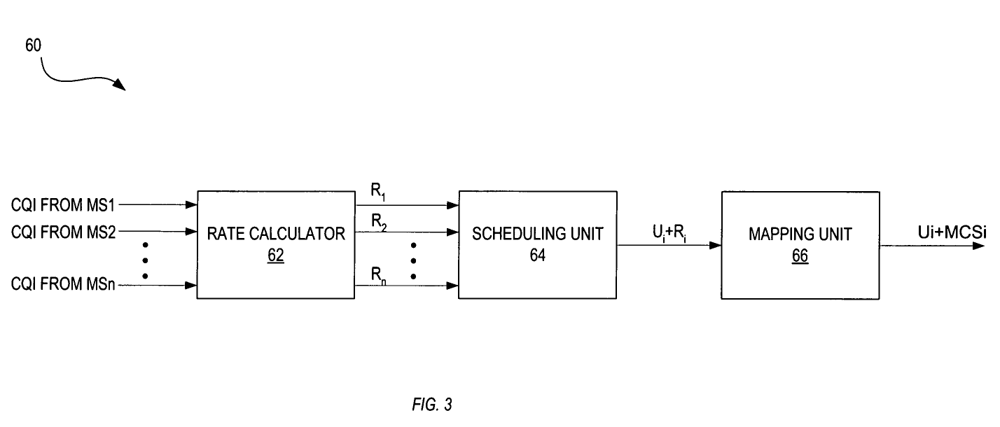

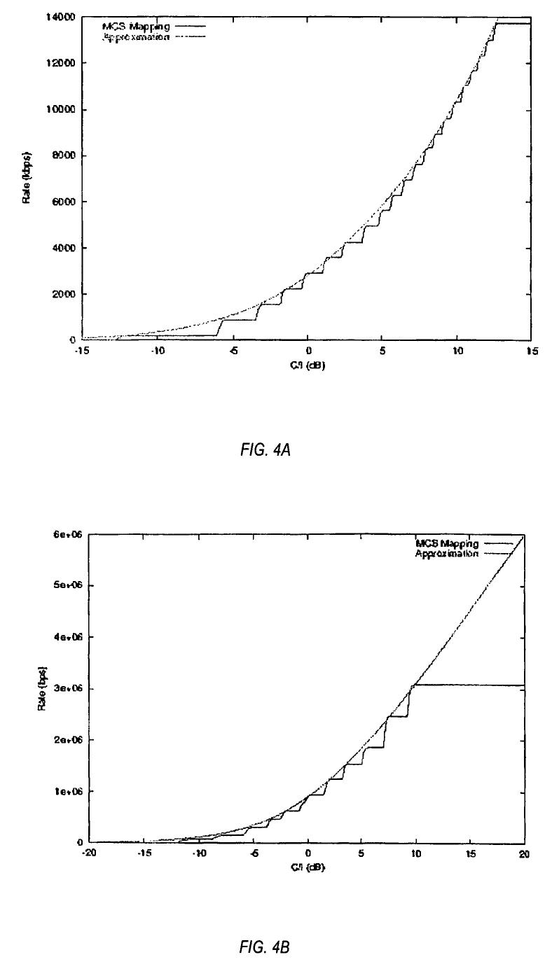

FIG. 3 illustrates a scheduler 60 according to one exemplary embodiment of the invention. The scheduler 60 comprises a rate calculator 62, scheduling unit 64, and mapping unit 66. The rate calculator 62 receives the channel quality indicators (CQIs) from the mobile stations 100 and uses the CQIs to calculate an achievable rate for each mobile station using a continuous function. For 1xEV-DV systems according to the IS-2000 standard, the achievable rate R may be calculated by:
R=B log(1+C/I) (1)
where C/I is the signal-to-interference plus noise ratio (SINR), and B is the effective bandwidth. In WCDMA systems, the achievable rate R may be calculated by:
R=(b+0.02x³)log(1+C/I) (2)
where x=10 log(C/I). FIGS. 4A and 4B graph the achievable rate as a function of C/I for 1xEV-DV and WCDMA systems, respectively.

The achievable rate for each mobile station is input to the scheduling unit 64. The scheduling unit 64 may use any known scheduling algorithm, such as a maximum throughput algorithm or proportional fairness algorithm, to schedule users. When maximum throughput scheduling is used, the scheduler 60 selects the mobile station 1000 with the highest achievable rate. When the scheduler 60 uses a proportional fairness criteria, the scheduler selects the mobile station 100 with the highest ratio of achievable rate to throughput. The scheduling unit 64 outputs the selected user Uᵢ and achievable rate Rᵢ for the scheduled user i to the mapping unit 66. The mapping unit 66 uses a look-up table to map the achievable rate Rᵢ for the selected user to one of a set of modulation and coding schemes. The selected modulation and coding scheme determines the actual scheduled rate of the user Uᵢ. The mapping of the achievable rate to the MCS coding scheme is shown in FIG. 4A and 4B.

The scheduled rate should be distinguished from the achievable rate Rᵢ computed by the rate calculator 62. The achievable rate Rᵢ is an estimate of the maximum rate at which the mobile station 100 could receive if the rate is infinitely variable. In most wireless communication systems, data transmission rates are limited to predefined rates. The scheduled rate output from the mapping unit 66 is one of the set of predefined rates defined by the applicable air interface.

The present invention enables the scheduler 60 to take into account small differences in C/I values in schedulers where the mapping to a modulation encoding scheme is done prior to the scheduling decision. Using more accurate rate determinations in the scheduling decision results in more efficient transmissions and, hence, improved system performance.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of scheduling use of a shared channel by a plurality of mobile stations, comprising:
receiving channel quality feedback from mobile stations using the shared channel;
determining achievable rates for said mobile stations using a continuous function based on said channel quality feedback; and
scheduling the mobile stations based on said achievable rates.

2. The method of claim 1 wherein said channel quality feedback from said mobile stations comprises a carrier to interference ratio.

3. The method of claim 2 wherein the carrier to interference ratio is a signal to interference plus noise ratio.

4. The method of claim 1 scheduling the mobile stations based on said achievable rates comprises selecting a mobile station to receive data during a given time period based on the achievable rate and determining a data transmission rate for the selected mobile station.

5. The method of claim 4 wherein the selected mobile station is the one with the highest achievable rate.

6. The method of claim 4 wherein the selected mobile station is the one with the highest ratio of achievable rate to throughput.

7. A base station comprising:
a receiver to receive channel quality feedback from a plurality of mobile stations communicating with the base station over a shared packet data channel; and
a scheduler operative to determine achievable rates for said mobile stations using a continuous function based on said channel quality feedback, and to schedule the mobile stations based on said achievable rates.

8. The base station of claim 7 wherein said channel quality feedback from said mobile stations comprises a carrier to interference ratio.

9. The base station of claim 8 wherein the carrier to interference ratio is a signal to interference plus noise ratio.

10. The base station of claim 7 wherein the scheduler selects a mobile station to receive data during a given time period and determines a data transmission rate for the selected mobile station based on the achievable rate.

11. The base station of claim 10 wherein the selected mobile station is the one with the highest achievable rate.

12. The base station of claim 10 wherein the selected mobile station is the one with the highest ratio of achievable rate to throughput.
